(19) United States
(12) Patent Application Publication
(10) Pub. No.: US 2026/0167091 A1
(43) Pub. Date: Jun. 18, 2026

(54) LAMP CONTROL SYSTEM, LAMP CONTROL METHOD, AND VEHICLE

(71) Applicant: HYUNDAI MOBIS CO., LTD., Seoul (KR)

(72) Inventor: Jun Young SUNG, Yongin-si (KR)

(73) Assignee: HYUNDAI MOBIS CO., LTD., Seoul (KR)

(21) Appl. No.: 19/312,536

(22) Filed: Aug. 28, 2025

(30) Foreign Application Priority Data
Dec. 17, 2024 (KR) 10-2024-0188874

(51) Int. Cl. B60Q 1/14; H05B 47/11

(52) U.S. Cl. CPC B60Q 1/1423; H05B 47/11; B60Q 2300/3321; B60Q 2300/337

(57) ABSTRACT

A lamp control system, as a lamp control system for a moving object, includes a lamp to emit a beam pattern; a memory to store driving data and refined data obtained by analyzing the driving data; and a processor to set a target time and a target light intensity for controlling the beam pattern based on the data stored in the memory and control a light intensity of the beam pattern to reach the target light intensity within the target time.

### CROSS-REFERENCE TO RELATED APPLICATIONS

This application claims the benefit of Korean Patent Application No. 10-2024-0188874, filed on Dec. 17, 2024, which is hereby incorporated by reference as if fully set forth herein.

### BACKGROUND

### Technical Field

The present embodiments are applicable to vehicles in all fields and, more particularly, relate to a lamp control system, lamp control method, and vehicle for sequentially controlling the light intensity of a lamp based on driving data.

### Discussion of the Related Art

As utilization of a lamp for a vehicle equipped with an LED light source continues to increase, a demand for high-beam and low-beam lamp modules for the vehicle with various performances is also growing. In particular, a trend of integrating the high-beam and low-beam modules for the vehicle is becoming a significant trend. This trend is well-received in the market because of low cost, small volume, simple structure, and a wide range of functions.

As people's interest in safety when driving the vehicle is increasing, a considerable number of driving accidents occur every year because of inappropriate use of the high-beams. A lamp module for the vehicle with an ADB (Adaptive Driving Beam) function may solve contradiction of high and low-beam use to some extent. In other words, it may provide excellent visibility to the vehicle and prevent glare to other vehicle drivers. The ADB function has a kind of smart control performance, and is able to control a lighting area and lighting brightness in real time by independently controlling each LED, thereby effectively preventing the glare to other vehicles and pedestrians.

Existing vehicles with the ADB function have been used in a way that a driver directly specifies a speed at which the ADB function is activated, and the ADB function is automatically activated when the vehicle travels at a speed equal to or higher than the corresponding speed. However, the existing scheme has a problem in that the lighting is controlled without considering an environment of a road on which the vehicle is traveling, so that the lighting becomes darker on a relatively dark road or becomes brighter in a relatively bright place, obstructing a view of the pedestrians or other drivers. In addition, the ADB function may be activated earlier than the driver wants, causing many malfunctions resulted from camera recognition errors, or an ADB function may be activated later than the driver wants, causing frustration.

A low beam is one of the driving lights of a vehicle, which illuminates the front of the vehicle during nighttime or in dark environments. The low beam generally serves to adjust the lighting to avoid dazzling other vehicles coming from the opposite direction or other road users.

The low beam is a headlight mounted on the front of the vehicle, which emits light. The lighting generally emits beams horizontally onto the road surface, providing sufficient visibility for the driver while minimizing glare for other vehicles and pedestrians.

However, a conventional low beam only allows the driver to set a low beam mode according to the driving conditions, and there is a problem in that it is difficult to efficiently control the light intensity of a lamp emitting beams according to a low beam pattern.

### SUMMARY

Accordingly, the present disclosure is directed to a lamp control system, lamp control method, and vehicle that substantially obviate one or more problems due to limitations and disadvantages of the related art.

The present disclosure is aimed at solving the aforementioned problems, and according to the embodiments, an object of the present disclosure is to efficiently control the reduction of the light intensity of a lamp based on driving data.

Furthermore, according to the embodiments, another object of the present disclosure is to efficiently control the light intensity of a lamp by considering various environmental factors, such as road conditions and lighting fixture information.

It will be appreciated by persons skilled in the art that the objects that could be achieved with the present disclosure are not limited to what has been particularly described hereinabove and the above and other objects that the present disclosure could achieve will be more clearly understood from the following detailed description.

To achieve these objects and other advantages and in accordance with the purpose of the disclosure, as embodied and broadly described herein, provided is a lamp control system for a moving object. The lamp control system includes: a lamp configured to emit a beam pattern; a memory configured to store driving data and refined data obtained by analyzing the driving data; and a processor configured to set a target time and a target light intensity for controlling the beam pattern based on the data stored in the memory and control a light intensity of the beam pattern to reach the target light intensity within the target time.

According to embodiments, the processor may be configured to set the target light intensity differently depending on a distance between the moving object and at least one other moving object, a length of a streetlight section, or a length of a tunnel section. The distance between the moving object and the at least one other moving object, the length of the streetlight section, and the length of the tunnel section may be included in the driving data.

According to embodiments, the target light intensity may be configured to have a smaller value as the distance between the moving object and the at least one other moving object decreases.

According to embodiments, the target light intensity may be configured to have a smaller value as the length of the streetlight section or the length of the tunnel section increases.

According to embodiments, the processor may be configured to set the target light intensity differently depending on an illumination value in the driving data.

According to embodiments, the target light intensity may be configured to have a smaller value as the illumination value increases.

According to embodiments, the processor may be configured to: configure a control amount per step based on the target time and the target light intensity and; sequentially control the light intensity of the beam pattern according to the control amount per step.

According to embodiments, the processor may be configured to configure the control amount per step based on a number of surrounding objects or weather information included in the driving data and indicated by the data.

In another aspect of the present disclosure, provided herein is a lamp control method for a moving object. The lamp control method is performed by a lamp control system having a lamp configured to emit a beam pattern in a forward direction and includes: extracting one or both of driving data and refined data obtained by analyzing the driving data; setting a target time and a target light intensity for controlling the beam pattern based on the extracted data; and controlling a light intensity of the beam pattern to reach the target light intensity within the target time.

In a further aspect of the present disclosure, provided herein is a moving object. The moving object includes: a lamp configured to emit a beam pattern; a memory configured to store driving data and refined data obtained by analyzing the driving data; and a processor configured to set a target time and a target light intensity for controlling the beam pattern based on the data stored in the memory and control a light intensity of the beam pattern to reach the target light intensity within the target time.

As is apparent from the above description, the present disclosure has effects as follows.

According to embodiments, the light intensity of a lamp may be efficiently controlled and reduced based on driving data. Thus, unnecessary power consumption of the lamp may be reduced, thereby saving energy.

According to embodiments, the light intensity of a lamp while considering various environmental factors such as road conditions and lighting fixture information, there is an effect of reducing the unnecessary power consumption of the lamp, thereby saving energy. Thus, unnecessary power consumption of the lamp may be reduced, thereby saving energy.

The effects obtainable from the present disclosure are not limited to those mentioned above. Other effects not explicitly mentioned will be clearly understood by those skilled in the art from the following description.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an overall block diagram of an autonomous vehicle to which an autonomous driving device is applicable;

FIG. 2 is an exemplary diagram illustrating an example where an autonomous driving device is applied to a vehicle;

FIG. 3 illustrates a lamp control system according to embodiments;

FIG. 4 illustrates a lamp control method according to embodiments;

FIGS. 5, 6, 7, 8, 9, and 10 illustrate examples of configuring a target light intensity according to embodiments; and

FIGS. 11 and 12 illustrate examples of configuring a step size according to embodiments.

### DETAILED DESCRIPTION

Preferred embodiments of embodiments will be described in detail, and examples of which will be illustrated in the accompanying drawings. The detailed description below with reference to the accompanying drawings is intended to describe the preferred embodiments of the embodiments rather than to illustrate only embodiments that may be implemented according to the embodiments. The detailed description below includes details to provide a thorough understanding of the embodiments. However, it will be apparent to one skilled in the art that the embodiments may be practiced without such details.

Most of terms used in the embodiments are generally chosen from those widely used in the art, but some terms are arbitrarily chosen by the applicant and meanings thereof are described in detail in the following description as necessary. Therefore, the embodiments should be understood based on the intended meanings of the terms, not on the mere names or meanings of the terms.

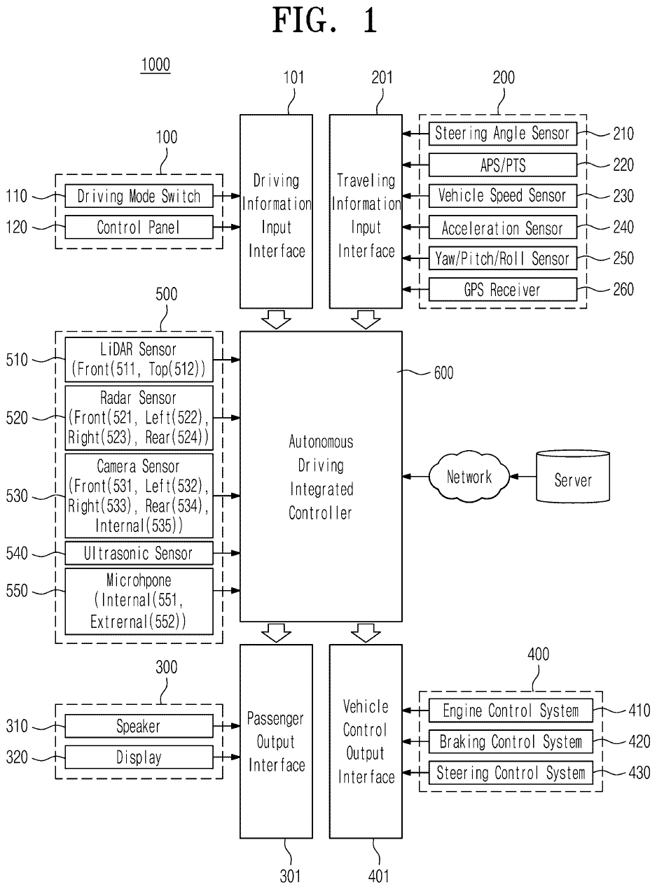

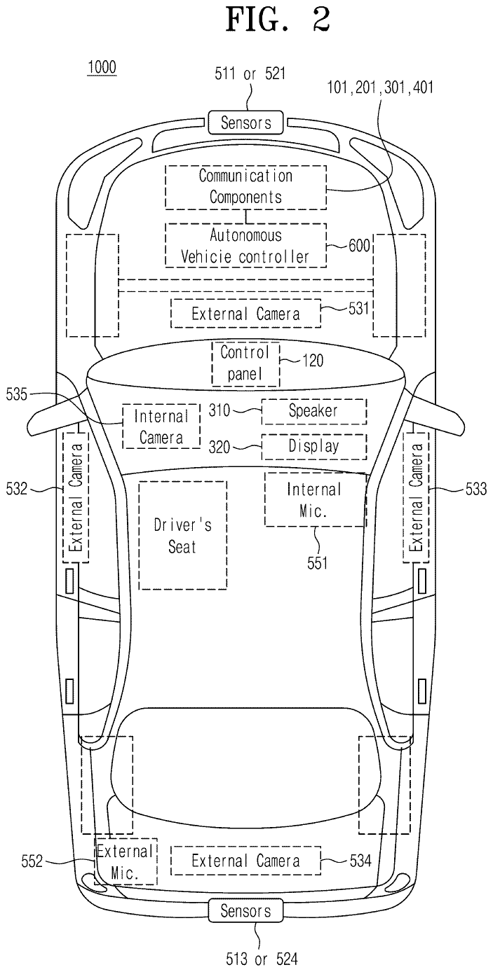

FIG. 1 is an overall block diagram of an autonomous vehicle to which an autonomous driving device is applicable. FIG. 2 is an exemplary diagram illustrating an example where an autonomous driving device is applied to a vehicle.

First, with reference to FIGS. 1 and 2, the structure and function of an autonomous driving control system (e.g., autonomous vehicle) to which the autonomous driving device according to the present embodiments is applicable will be described.

As shown in FIG. 1, an autonomous vehicle 1000 may be implemented based on an autonomous driving integrated controller 600, which transmits and receives data necessary for the autonomous driving control of the autonomous vehicle through a driving information input interface 101, a travel information input interface 201, a passenger output interface 301, and an autonomous vehicle control output interface 401. However, the autonomous driving integrated controller 600 may be referred to simply as a controller, processor, or control unit in this specification.

The autonomous driving integrated controller 600 may obtain driving information based on the operation of a passenger on a user input unit 100 in an autonomous driving mode or a manual driving mode through the driving information input interface 101. As shown in FIG. 1, the user input unit 100 may include a driving mode switch 110 and a control panel 120 (for example, a navigation terminal mounted in the autonomous driving vehicle, a smartphone or tablet PC carried by the passenger, etc.). Accordingly, the driving information may include driving mode information of the autonomous driving vehicle and navigation information.

For example, a driving mode (i.e., autonomous driving mode/manual driving mode or sports mode/eco mode/safe mode/normal mode) of the autonomous vehicle determined based on passenger's manipulation of the driving mode switch 110 may be transmitted to the autonomous driving integrated controller 600 as the driving information via the driving information input interface 101.

In addition, the navigation information such as a passenger's destination and a route to the destination (the shortest route, a preferred route, or the like selected by the passenger among candidate routes to the destination) input by the passenger via the control panel 120 may be transmitted to the autonomous driving integrated controller 600 as the driving information via the driving information input interface 101.

In one example, the control panel 120 may be implemented as a touch screen panel that provides a user interface (UI) for the passenger to input or modify information for controlling the autonomous driving of the autonomous vehicle, and in this case, the driving mode switch 110 described above may be implemented as a touch button on the control panel 120.

In addition, the autonomous driving integrated controller 600 may obtain travel information indicating a travel state of the autonomous vehicle via the travel information input interface 201. The travel information may include various information indicating the travel state and a behavior of the autonomous vehicle, such as a steering angle formed by the passenger manipulating a steering wheel, an accelerator pedal stroke or a brake pedal stroke generated by pressing an accelerator pedal or a brake pedal, and a behavior of the autonomous vehicle including a vehicle speed, an acceleration, a yaw, a pitch, and a roll. Each of the travel information may be detected by a driving controller 200 including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the travel information of the autonomous vehicle may include location information of the autonomous vehicle, and the location information of the autonomous vehicle may be obtained via a global positioning system (GPS) receiver 260 applied to the autonomous vehicle. Such travel information may be transmitted to the autonomous driving integrated controller 600 via the travel information input interface 201 and used to control the travel of the autonomous vehicle in the autonomous driving mode or the manual driving mode of the autonomous vehicle.

In addition, the autonomous driving integrated controller 600 may transmit travel state information provided to the passenger in the autonomous driving mode or the manual driving mode of the autonomous vehicle to an output unit 300 via the passenger output interface 301. That is, the autonomous driving integrated controller 600 may transmit the travel state information of the autonomous vehicle to the output unit 300, thereby allowing the passenger to identify an autonomous driving state or a manual driving state of the autonomous vehicle based on the travel state information output via the output unit 300. The travel state information may include various information indicating the travel state of the autonomous vehicle, such as a current driving mode, a shift range, the vehicle speed, and the like of the autonomous vehicle.

In addition, when determining that a warning is necessary for the passenger in the autonomous driving mode or the manual driving mode of the autonomous vehicle together with the travel state information described above, the autonomous driving integrated controller 600 may transmit warning information to the output unit 300 via the passenger output interface 301, so that the output unit 300 may output the warning to the passenger. To output such travel state information and warning information audibly and visually, the output unit 300 may include a speaker 310 and a display device 320 as illustrated in FIG. 1. In this regard, the display device 320 may be implemented as the same device as the control panel 120 described above, or may be implemented as a separate, independent device.

In addition, the autonomous driving integrated controller 600 may transmit control information for controlling the travel of the autonomous vehicle in the autonomous driving mode or the manual driving mode of the autonomous vehicle to a lower control system 400 applied to the autonomous vehicle via the autonomous vehicle control output interface 401. The lower control system 400 for controlling the control of the autonomous vehicle may include an engine control system 410, a braking control system 420, and a steering control system 430 as illustrated in FIG. 1, and the autonomous driving integrated controller 600 may transmit engine control information, braking control information, and steering control information as the control information to each lower control system 410, 420, and 430 via the autonomous vehicle control output interface 401. Accordingly, the engine control system 410 may control the vehicle speed and the acceleration of the autonomous vehicle by increasing or decreasing an amount of fuel supplied to an engine, the braking control system 420 may control braking of the autonomous vehicle by adjusting a braking force of the autonomous vehicle, and the steering control system 430 may control steering of the autonomous vehicle via a steering device (e.g., a motor driven power steering (MDPS) system) applied to the autonomous vehicle.

As described above, the autonomous driving integrated controller 600 of the present embodiment may obtain the driving information based on the manipulation of the passenger and the travel information indicating the travel state of the autonomous vehicle via the driving information input interface 101 and the travel information input interface 201, respectively, may transmit the travel state information and the warning information generated based on an autonomous driving algorithm to the output unit 300 via the passenger output interface 301, and may operate such that the travel control of the autonomous vehicle is performed by transmitting the control information generated based on the autonomous driving algorithm to the lower control system 400 via the autonomous vehicle control output interface 401.

In one example, to ensure stable autonomous driving of the autonomous vehicle, it is necessary to continuously monitor the travel state by accurately measuring a travel environment of the autonomous vehicle and control the travel based on the measured travel environment. To this end, the autonomous driving device of the present embodiment may include a sensing module 500 for detecting an object surrounding the autonomous vehicle, such as a surrounding autonomous vehicle, the pedestrian, the road, or a fixed facility (e.g., a traffic light, a milestone, a traffic sign, a construction fence, and the like), as illustrated in FIG. 1.

The sensing module 500 may include one or more of a lidar sensor 510, a radar sensor 520, and a camera sensor 530 for detecting the surrounding object outside the autonomous vehicle as illustrated in FIG. 1.

The lidar sensor 510 may detect the surrounding object outside the autonomous vehicle by transmitting a laser signal to surroundings of the autonomous vehicle and receiving a signal reflected from the corresponding object and returned, and may detect the surrounding object located within predefined set distance, set vertical field of view, and set horizontal field of view based on specifications thereof. The lidar sensor 510 may include a front lidar sensor 511, an upper lidar sensor 512, and a rear lidar sensor 513 installed on a front surface, an upper portion, and a rear surface of the autonomous vehicle, respectively, but the installation locations and the number of installed units thereof are not limited to those in a specific embodiment. A threshold value for determining validity of the laser signal reflected from the corresponding object and returned may be stored in advance in a memory (not shown) of the autonomous driving integrated controller 600, and the autonomous driving integrated controller 600 may determine a location (including a distance to the corresponding object), a speed, and a moving direction of the corresponding object by measuring a time it takes for the laser signal transmitted via the lidar sensor 510 to be reflected from the corresponding object and returned.

The radar sensor 520 may detect the surrounding object outside the autonomous vehicle by emitting an electromagnetic wave to surroundings of the autonomous vehicle and receiving a signal reflected from the corresponding object and returned, and may detect the surrounding object located within the predefined set distance, set vertical angle of view, and set horizontal angle of view range based on specifications thereof. The radar sensor 520 may include a front radar sensor 521, a left radar sensor 521, a right radar sensor 522, and a rear radar sensor 523 installed on the front surface, a left side surface, a right side surface, and the rear surface of the autonomous vehicle, respectively, but the installation locations and the number of installed units thereof are not limited to those in a specific embodiment. The autonomous driving integrated controller 600 may determine the location (including the distance to the corresponding object), the speed, and the moving direction of the corresponding object by analyzing power of the electromagnetic wave transmitted and received via the radar sensor 520.

The camera sensor 530 may detect the surrounding object outside the autonomous vehicle by capturing the surroundings of the autonomous vehicle, and may detect the surrounding object located within the predefined set distance, set vertical field of view, and set horizontal field of view based on specifications thereof.

The camera sensor 530 may include a front camera sensor 531, a left camera sensor 532, a right camera sensor 533, and a rear camera sensor 534 installed on the front surface, the left side surface, the right side surface, and the rear surface of the autonomous vehicle, respectively, but the installation locations and the number of installed units thereof are not limited to those in a specific embodiment. The autonomous driving integrated controller may determine the location (including the distance to the corresponding object), the speed, the moving direction, and the like of the corresponding object by applying predefined image processing to the image captured via the camera sensor 530.

In addition, an internal camera sensor 535 for capturing interior of the autonomous vehicle may be mounted at a predetermined location (e.g., a rearview mirror) inside the autonomous vehicle, and the autonomous driving integrated controller 600 may monitor a behavior and a state of the passenger based on the image obtained via the internal camera sensor 535 and output a guidance or the warning to the passenger via the output unit 300 described above.

In addition to the lidar sensor 510, the radar sensor 520, and the camera sensor 530, the sensing module 500 may further include an ultrasonic sensor 540 as illustrated in FIG. 1, and various types of sensors for detecting the surrounding object of the autonomous vehicle may be further employed in the sensing module 500.

To help understand the present embodiment, FIG. 2 shows an example in which the front lidar sensor 511 or the front radar sensor 521 is installed on the front surface of the autonomous vehicle, the rear lidar sensor 513 or the rear radar sensor 523 is installed on the rear surface of the autonomous vehicle, and the front camera sensor 531, the left camera sensor 532, the right camera sensor 533, and the rear camera sensor 534 are installed on the front surface, the left side surface, the right side surface, and the rear surface of the autonomous vehicle, respectively. However, as described above, the installation locations and the number of installed units of the respective sensors are not limited to those in a specific embodiment.

In addition, the sensing module 500 may further include a bio-sensor for detecting bio-signals of the passenger (e.g., heart rate, electrocardiogram, respiration, blood pressure, body temperature, brain wave, blood flow (pulse wave), blood sugar, and the like) to determine the state of the passenger in the autonomous vehicle. The bio-sensor may include a heart rate sensor, an electrocardiogram sensor, a respiration sensor, a blood pressure sensor, a body temperature sensor, an electroencephalogram sensor, a photoplethysmography sensor, a blood sugar sensor, and the like.

Finally, the sensing module 500 additionally adds a microphone 550, and an internal microphone 551 and an external microphone 552 are used for different purposes.

The internal microphone 551 may be used, for example, to analyze a voice of the passenger in the autonomous vehicle 1000 based on AI or the like or to immediately respond to a direct voice command.

On the other hand, the external microphone 552 may be used for analyzing various sounds generated from the outside of the autonomous vehicle 1000 using various analysis tools such as deep learning and responding appropriately thereto for safe travel or the like.

For reference, components shown in FIG. 2 may perform the same or similar functions as those shown in FIG. 1, and FIG. 2 illustrates relative positional relationships of the components (based on the interior of the autonomous vehicle 1000) in more detail compared to FIG. 1.

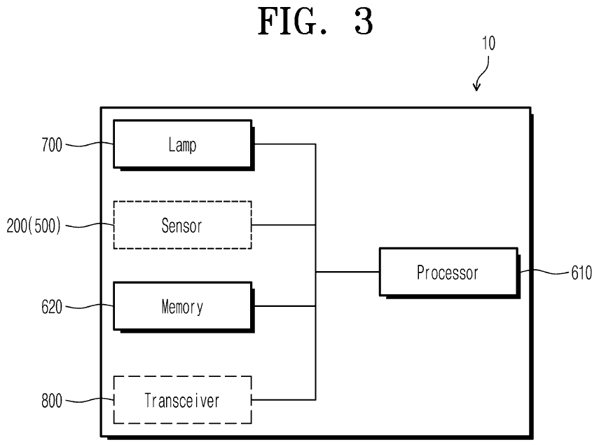

FIG. 3 illustrates a lamp control system according to embodiments.

Referring to FIG. 3, the lamp control system 10 according to the embodiments may include a lamp 700, a memory 620, and a processor 610. The lamp control system 10 is included in a moving object 1000 and may be mounted or installed on the moving object 1000. In the present disclosure, a moving object refers to an object having mobility as a transportation means, and may include, for example, vehicles, drones, robots, and the like.

The lamp 700, as a kind of output unit that irradiates a beam in a forward direction of the vehicle based on a beam pattern, may include a pair of lamps. More specifically, the lamp 700 may be a kind of a headlamp, composed of a pair of headlamps on left and right portions of the front surface of the moving object (or vehicle). In general, the headlamp or a headlight may include a low beam, a high beam, a turn signal, a daytime running light, a side light, and the like. For example, the lamp 700 controlled by the processor 610 of the lamp control system 10 according to the embodiments may correspond to a downward beam that emits a beam in the forward direction of the vehicle according to the pattern of a low beam mode.

The memory 620 may store the driving data of the moving object 1000. Additionally or alternatively, the memory 620 may store refined data by analyzing the driving data of the moving object 1000. The driving data may include information on the distance between the moving object 1000 and another moving object, information on the length of a streetlight section when the moving object 1000 is driving through the section, information on the length of a tunnel section when the moving object 1000 is driving through the section, or information on the current illumination level. More specifically, the driving data may be obtained as follows: information on the distance to other moving objects, information on the length of the streetlight section, information on the length of the tunnel section, or information on illumination is collected based on the current location of the moving object 1000, and the collected information is quantified and processed.

The lamp control system 10 may be configured to receive location-based driving data from a server. That is, the server may collect navigation information of the currently driving moving object 1000 or GPS information on the moving object 1000, advanced driver assistance system (ADAS) related information on the moving object 1000, or output interface information for vehicle control of the moving object 1000, and store, analyze, process, or manage the information.

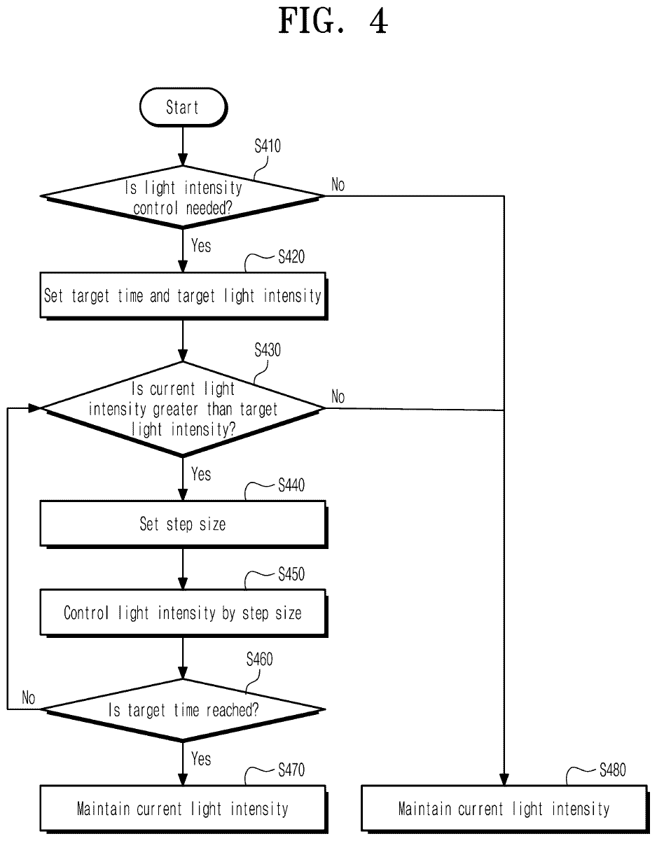

The processor 610 may control the lamp 700 using the driving data stored in the memory 620. More specifically, the processor 610 may control the light intensity of a beam pattern that the lamp 700 emits. The control of the light intensity of the beam pattern by the processor 610 will be described in detail with reference to FIG. 4.

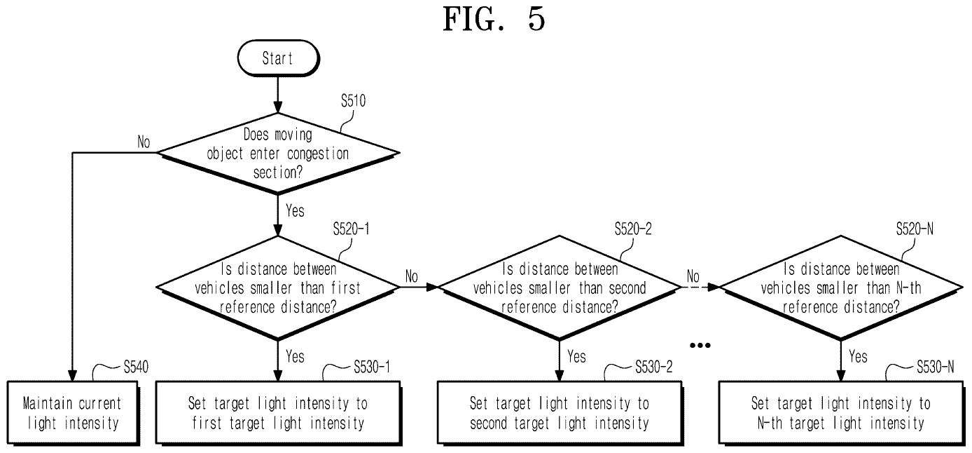

The lamp control system 10 may further include sensors 200 or 500. The sensors 200 or 500 may include sensors 210, 220, 230, 240, 250, and 260 configured to acquire information related to the movement of the moving object, or sensors 510, 520, 530, and 540 configured to acquire information about the surrounding environment of the moving object. Information on the current location of the moving object 1000 may be acquired through the sensors 200 or 500. Additionally, information on the locations of surrounding vehicles, such as a vehicle in front or an oncoming vehicle, may be acquired through the sensors 200 or 500. Furthermore, the sensors 200 or 500 may acquire information that forms the basis of the driving data. This will be explained in detail provided with reference to FIGS. 5 to 12.

The lamp control system 10 may further include a transceiver 800. The transceiver 800 may be configured to receive location-based driving data from the server. Additionally, the transceiver 800 may be configured to transmit location-based driving data on the moving object 1000 having the lamp control system 10 mounted or installed thereon to the server.

FIG. 4 illustrates a lamp control method according to embodiments.

FIG. 4 illustrates a method by which the vehicle in FIGS. 1 and 2 or the lamp control system 10 in FIG. 3 controls the lamp based on the autonomous driving integrated controller 600 in FIGS. 1 and 2 or the processor 610 in FIG. 3.

The lamp control method according to the embodiments may include: extracting driving data or extracting refined data by analyzing the driving data; setting a target time and target light intensity for controlling a beam pattern based on the extracted data; and controlling the light intensity of the beam pattern to reach the target light intensity within the target time.

More specifically, referring to FIG. 4, the lamp control system 10/lamp control method according to the embodiments may determine whether control of the light intensity of the beam pattern emitted by the lamp 700 is required (S410). Step S410 will be explained in detail in FIGS. 5 to 10.

If it is determined in step S410 that the control of the light intensity of the beam pattern is required, the lamp control system 10/lamp control method according to the embodiments may set the target time and target light intensity (S420).

The target time may be configured based on the driving data stored in the memory 620. The target time is the time for controlling the light intensity, and the lamp control system 10/lamp control method according to the embodiments may control the light intensity of the lamp 700 within the configured target time. Therefore, when the target time is set relatively long, the lamp control system 10/lamp control method according to the embodiments may control the light intensity of the lamp 700 over a relatively long period. Alternatively, when the target time is set relatively short, the lamp control system 10/lamp control method according to the embodiments may control the light intensity of the lamp 700 within a relatively short period.

Similarly, the target light intensity may be configured based on the driving data stored in the memory 620. The target light intensity may have a value smaller than the current light intensity of the beam pattern emitted by the lamp 700. In other words, if it is determined in step S410 that the control of the light intensity of the beam pattern is required, it may correspond to a case where the light intensity of the beam pattern needs to be reduced. The target light intensity may be configured differently based on information in the driving data. This will be explained in detail with reference to FIGS. 5 to 10.

After the target time and target light intensity are configured in step S420, the current light intensity of the beam pattern emitted by the lamp 700 may be compared with the target light intensity (S430). More specifically, it may be determined whether the current light intensity of the lamp 700 exceeds the target light intensity (S430). Step S430 may be performed by the processor 610 of the lamp control system 10.

If it is determined in step S430 that the current light intensity exceeds the target light intensity, a step size may be configured (S440), and the light intensity of the beam pattern emitted by the lamp 700 may be controlled by the configured step size (S450). The step size may correspond to the amount of control per step. In other words, in step S450, the current light intensity may be reduced by the step size configured in step S440.

The step size may be configured based on the target time and target light intensity configured in step S420. For example, the step size may satisfy Equation 1.

$${S}_{1} = ( {l}_{o} - {l}_{t} ) / {t}_{1} \qquad [ Equation 1 ]$$

In Equation 1, S₁ represents the step size, I₀ represents the current light intensity, Iₜ represents the target light intensity, and t₁ represents the target time.

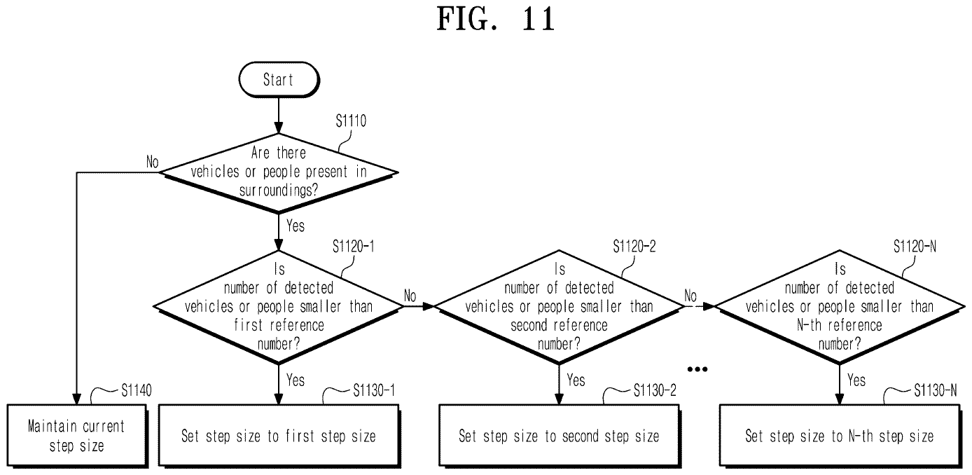

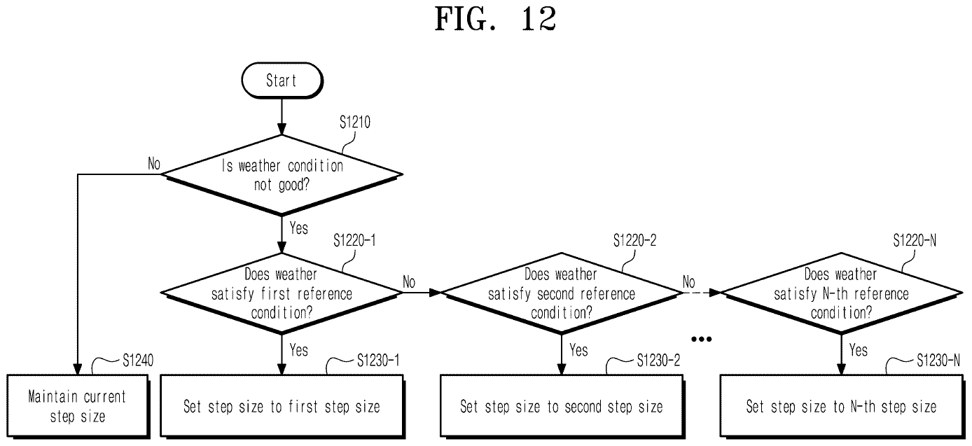

In other words, the step size is a value obtained by dividing the amount of light intensity that needs to be reduced to the target light intensity by the target time, which represents the amount of light intensity to be controlled in one step. Therefore, when the target time is relatively long, the lamp control system 10/lamp control method according to the embodiments may set the step size to a relatively small value such that a relatively small amount of light intensity is controlled in one step. Alternatively, when the target time is relatively short, the lamp control system 10/lamp control method according to the embodiments may set the step size to a relatively large value such that a relatively large amount of light intensity is controlled in one step. The step size may be configured to have different values based on the driving data. This will be explained in detail in FIGS. 11 and 12.

After the light intensity of the lamp 700 is reduced by the set step size in step S450, it may be determined whether the target time configured in step S420 is reached (S460). If it is determined in step S460 that the target time is reached, the current light intensity may be maintained (S570). The current light intensity maintained in step S570 may correspond to the light intensity of the lamp 700 after step S450. In other words, if it is determined that the target time is reached even though the light intensity of the lamp 700 after step S450 does not reach the target light intensity, the lamp 700 may be controlled to maintain the current light intensity (S470). In this case, the current light intensity may refer to the light intensity reduced by the step size in one step.

On the other hand, if it is determined in step S460 that the target time is not reached, the current light intensity of the beam pattern emitted by the lamp 700 may be compared again with and the target light intensity (S430). In this case, the current light intensity may refer to the light intensity of the lamp 700 after step S450, in other words, the light intensity reduced by the step size in one step.

If it is determined in step S430 that the current light intensity exceeds the target light intensity, the step size may be reset (S440), and the light intensity of the beam pattern emitted by the lamp 700 may be controlled by the step size (S450). In this case, the reset step size may have a different value from the initially set step size.

In other words, the step size set again after the light intensity is controlled in one step may be configured to satisfy Equation 2 below.

$${S}_{2} = ( {l}_{1} - {l}_{t} ) / {t}_{2} \qquad [ Equation 2 ]$$

In Equation 2, S₂ represents the step size, I₁ represents the current light intensity, Iₜ represents the target light intensity, and t₂ represents the target time. More specifically, I₁ refers to the light intensity after the light intensity is reduced in one step, and t₂ represents the time taken when the light intensity is controlled in one step within the target time.

In other words, the lamp control system 10/lamp control method according to the embodiments does not control the light intensity of the lamp 700 to the target light intensity all at once, but may set the amount of control per step (step size) and sequentially control the light intensity of the lamp 700 to reach the target light intensity by controlling the light intensity by the set step size. Therefore, the lamp control system 10/lamp control method according to the embodiments has the effect of controlling the light intensity of the lamp 700 of the moving object 1000 sequentially and slowly such that other moving objects or drivers do not notice the control of the light intensity of the lamp 700.

After the light intensity of the lamp 700 is reduced by the reset step size in step S450, it may be determined again whether the target time set in step S420 is reached (S460). If it is determined in step S460 that the target time is reached, the current light intensity may be maintained (S570). In this case, the current light intensity may refer to the light intensity after the light intensity is reduced twice.

On the other hand, if it is determined in step S460 that the target time is not reached, the current light intensity of the beam pattern emitted by the lamp 700 may be compared again with the target light intensity (S430), and the corresponding process may be repeated.

Alternatively, if it is determined in step S410 that light intensity control is not needed, the lamp control system 10/lamp control method according to the embodiments may control the lamp 700 to maintain the current light intensity (S480). In this case, the current light intensity may correspond to the light intensity in a state where no reduction in light intensity has occurred.

Alternatively, if it is determined in step S430 that the current light intensity is less than the target light intensity or reaches the target light intensity, the lamp control system 10/lamp control method according to the embodiments may control the lamp 700 to maintain the current light intensity (S480). In this case, the current light intensity may correspond to the light intensity after being reduced in one step or o the light intensity after being reduced in multiple steps.

FIGS. 5 to 10 illustrate examples of setting a target light intensity according to embodiments.

FIGS. 5 to 10 illustrate methods by which the vehicle in FIGS. 1 and 2 or the lamp control system 10 in FIG. 3 controls the lamp based on the autonomous driving integrated controller 600 in FIGS. 1 and 2 or the processor 610 in FIG. 3.

First, referring to FIG. 5, the lamp control system 10/lamp control method according to the embodiments may determine whether the moving object 1000 enters a congestion area (S510). That is, entering a congestion area may correspond to a case where control of the light intensity of the beam pattern is necessary as shown in FIG. 4. In step S510, it may be determined whether the moving object 1000 enters the congestion area based on driving data or refined data stored in the memory 620. Alternatively, in step S510, it may be determined whether the moving object 1000 enters the congestion area based on information on the location of the moving object 1000 measured by the sensors 200 or 500.

If it is determined in step S510 that the moving object 1000 enters the congestion area, the lamp control system 10/lamp control method according to the embodiments may set the target time and target light intensity as explained in FIG. 4 (S420). In this case, as shown in FIG. 5, the lamp control system 10/lamp control method according to the embodiments may determine whether the distance between vehicles is smaller than a reference distance (S520-1, S520-2, . . . , S520-N). The distance between vehicles may refer to the distance between the moving object 1000 and another moving object. More specifically, the distance between vehicles may refer to the distance between the moving object 1000 and the nearest moving object located in front of the moving object 1000.

First, the lamp control system 10/lamp control method according to the embodiments may determine whether the distance between vehicles is smaller than a first reference distance (S520-1). If it is determined in step S520-1 that the distance between vehicles is smaller than the first reference distance, the target light intensity set in step S420 may be configured to correspond to a first target light intensity (S530-1).

Alternatively, if it is determined in step S520-1 that the distance between vehicles is greater than or equal to the first reference distance, it may be determined whether the distance between vehicles is smaller than a second reference distance (S520-2). In this case, the second reference distance may be greater than the first reference distance. Then, if it is determined in step S520-2 that the distance between vehicles is smaller than the second reference distance, the target light intensity set in step S420 may be configured to correspond to a second target light intensity (S530-2). The second target light intensity may be greater than the first target light intensity.

Alternatively, if it is determined in step S520-2 that the distance between vehicles is greater than or equal to the second reference distance, it may be determined whether the distance between vehicles is smaller than a third reference distance. This process may be repeated until it is determined whether the distance between vehicles is smaller than an N-th reference distance (S520-N). In this case, the third reference distance may be greater than the second reference distance. In other words, the relationship between reference distances may be as follows: first reference distance<second reference distance<third reference distance< . . . <N-th reference distance. If it is determined that the distance between vehicles is smaller than the third reference distance, the target light intensity set in step S420 may be set to correspond to a third target light intensity. If the distance between vehicles is smaller than the N-th reference distance, the target light intensity set in step S420 may be set to N-th target light intensity (S530-N). In this case, the third target light intensity may be greater than the second target light intensity. In other words, the relationship between target light intensities may be as follows: first target light intensity<second target light intensity<third target light intensity< . . . <N-th target light intensity.

In other words, the lamp control system 10/lamp control method according to the embodiments may set the target light intensity differently depending on the distance between vehicles when the moving object 1000 enters the congestion area. More specifically, the lamp control system 10/lamp control method according to the embodiments may set the target light intensity to the minimum value as the distance between vehicles between the moving object 1000 and another moving object decreases. The lamp control system 10/lamp control method according to the embodiments may have the effect of reducing power consumption by minimizing the target light intensity of the lamp 700 when the moving object 1000 is located in a congestion area, and when the distance between vehicles is short with many other moving objects nearby.

Additionally, if it is determined in step S510 that the moving object 1000 does not enter a congestion area, it corresponds to a case where light intensity control is not needed, and therefore, the current light intensity may be maintained (S540). In this case, the current light intensity may correspond to the light intensity in a state where no reduction in light intensity has occurred.

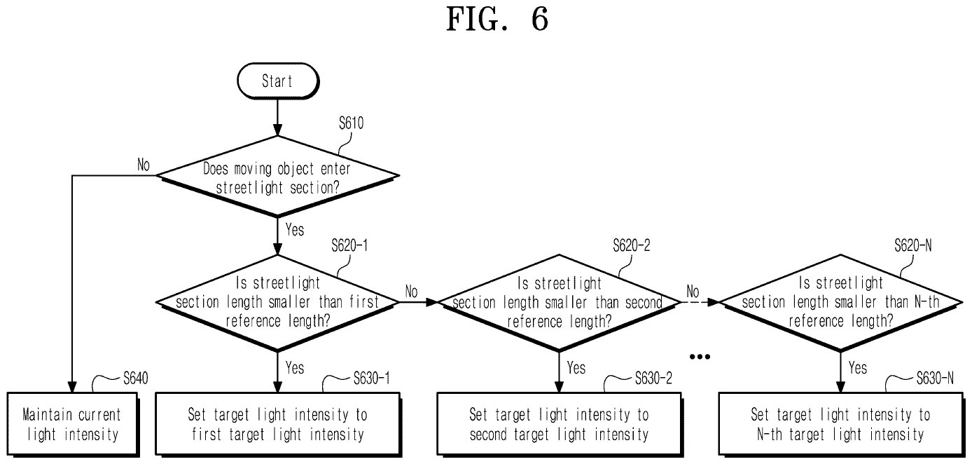

Alternatively, referring to FIG. 6, the lamp control system 10/lamp control method according to the embodiments may determine whether the moving object 1000 enters a streetlight section (S610). That is, if the moving object enters the streetlight section, it may correspond to a case where light intensity control is needed, as shown in the beam pattern in FIG. 4. In step S610, it may be determined whether the moving object enters the streetlight section based on driving data or refined data stored in the memory 620. Alternatively, in step S610, it may be determined whether the moving object enters the streetlight section based on information on the location of the moving object 1000 measured by the sensors 200 or 500.

If it is determined in step S610 that the moving object 1000 enters the streetlight section, the lamp control system 10/lamp control method according to the embodiments may set the target time and target light intensity (S420) as explained in FIG. 4. In this case, as shown in FIG. 6, the lamp control system 10/lamp control method according to the embodiments may determine whether the length of the streetlight section is smaller than a reference length (S620-1, S620-2, . . . , S620-N). The length of the streetlight section may refer to the total length of the streetlight section that the moving object 1000 enters.

First, the lamp control system 10/lamp control method according to the embodiments may determine whether the length of the streetlight section is smaller than a first reference length (S620-1). Then, if it is determined in step S620-1 that the length of the streetlight section is smaller than the first reference length, the target light intensity set in step S420 may be configured to correspond to a first target light intensity (S630-1).

Alternatively, if it is determined in step S620-1 that the length of the streetlight section is greater than or equal to the first reference length, it may be determined whether the length of the streetlight section is smaller than a second reference length (S620-2). In this case, the second reference length may be greater than the first reference length. If it is determined in step S620-2 that the length of the streetlight section is smaller than the second reference length, the target light intensity set in step S420 may be configured to correspond to a second target light intensity (S630-2). The second target light intensity may be smaller than the first target light intensity.

Alternatively, if it is determined in step S620-2 that the length of the streetlight section is greater than or equal to the second reference length, it may be determined whether the length of the streetlight section is smaller than a third reference length. This process may be repeated until it is determined whether the length of the streetlight section is smaller than an N-th reference length (S620-N). In this case, the third reference length may be greater than the second reference length. That is, the relationship between reference distances may be as follows: first reference distance<second reference distance<third reference distance< . . . <N-th reference distance. If it is determined that the length of the streetlight section is smaller than the third reference length, the target light intensity set in step S420 may be configured to correspond to a third target light intensity. Additionally, if the length of the streetlight section is smaller than the N-th reference distance, the target light intensity configured in step S420 may be configured to correspond to an N-th target light intensity (S630-N). In this case, the third target light intensity may be smaller than the second target light intensity. Thus, the relationship between target light intensities may be as follows: first target light intensity>second target light intensity>third target light intensity> . . . >N-th target light intensity.

That is, the lamp control system 10/lamp control method according to the embodiments may set the target light intensity differently depending on the length of the streetlight section when the moving object 1000 enters the streetlight section. More specifically, the lamp control system 10/lamp control method according to the embodiments may set the target light intensity to the minimum value as the length of the streetlight section increases. The lamp control system 10/lamp control method according to the embodiments has the effect of reducing power consumption by minimizing the target light intensity of the lamp 700 when the moving object 1000 is located in a streetlight section, and when the length of the streetlight section is long and the surrounding area is bright due to streetlights.

Additionally, if it is determined in step S610 that the moving object 1000 does not enter a streetlight section, it corresponds to a case where light intensity control is not needed, and thus, the current light intensity may be maintained (S640). In this case, the current light intensity may correspond to the light intensity in a state where no reduction in light intensity has occurred.

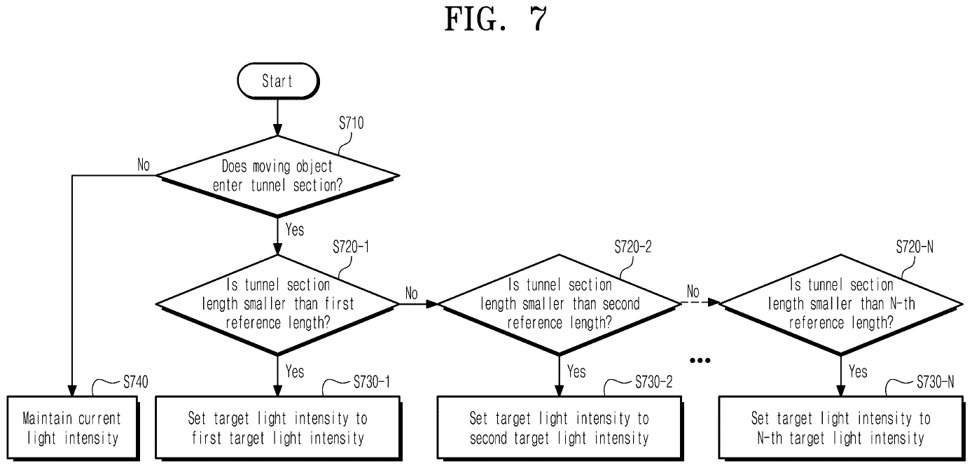

Alternatively, referring to FIG. 7, the lamp control system 10/lamp control method according to the embodiments may determine whether the moving object 1000 enters a tunnel section (S710). That is, entering a tunnel section may correspond to a case where control of the light intensity of the beam pattern is necessary as shown in FIG. 4. In step S710, it may be determined whether the moving object 1000 enters the tunnel section based on driving data or refined data stored in the memory 620. Alternatively, in step S710, it may be determined whether the moving object 1000 enters the tunnel section based on information on the location of the moving object 1000 measured by the sensors 200 or 500.

If it is determined in step S710 that the moving object 1000 enters the tunnel section, the lamp control system 10/lamp control method according to the embodiments may set the target time and target light intensity as explained in FIG. 4 (S420). In this case, as shown in FIG. 7, the lamp control system 10/lamp control method according to the embodiments may determine whether the length of the tunnel section is smaller than a reference length (S720-1, S720-2, . . . , S720-N). The length of the tunnel section may refer to the total length of the tunnel section that the moving object 1000 enters.

First, the lamp control system 10/lamp control method according to the embodiments may determine whether the length of the tunnel section is smaller than a first reference length (S720-1). Then, if it is determined in step S720-1 that the length of the tunnel section is smaller than the first reference length, the target light intensity set in step S420 may be configured to correspond to a first target light intensity (S730-1).

Alternatively, if it is determined in step S720-1 that the length of the tunnel section is greater than or equal to a first reference length, it may be determined whether the length of the tunnel section is smaller than a second reference length (S720-2). In this case, the second reference length may be greater than the first reference length. Then, if it is determined in step S720-2 that the length of the tunnel section is smaller than the second reference length, the target light intensity set in step S420 may be set a second target light intensity (S730-2). The second target light intensity may be smaller than the first target light intensity.

Alternatively, if it is determined in step S720-2 that the length of the tunnel section is greater than or equal to the second reference length, it may be determined whether the length of the tunnel section is smaller than a third reference length. This process may be repeated until it is determined whether the length of the tunnel section is smaller than an N-th reference length (S720-N). In this case, the third reference length may be greater than the second reference length. In other words, the relationship between reference lengths may be as follows: first reference length<second reference length<third reference length< . . . <N-th reference length. If it is determined that the length of the tunnel section is smaller than the third reference length, the target light intensity set in step S420 may be configured to correspond to a third target light intensity. If the length of the tunnel section is smaller than the N-th reference length, the target light intensity set in step S420 may be configured to correspond to an N-th target light intensity (S730-N). In this case, the third target light intensity may be smaller than the second target light intensity. In other words, the relationship between target light intensities may be as follows: first target light intensity>second target light intensity>third target light intensity> . . . >N-th target light intensity.

In other words, the lamp control system 10/lamp control method according to the embodiments may set the target light intensity differently depending on the length of the tunnel section when the moving object 1000 enters the tunnel section. More specifically, the lamp control system 10/lamp control method according to the embodiments may set the target light intensity to the minimum value as the length of the tunnel section increases. The lamp control system 10/lamp control method according to the embodiments has the effect of reducing power consumption by minimizing the target light intensity of the lamp 700. When the moving object 1000 is driving through a tunnel section, and when the tunnel section is long, and the surrounding area is bright due to tunnel interior lighting.

Additionally, if it is determined in step S710 that the moving object 1000 does not enter a tunnel section, it corresponds to a case where light intensity control is not needed, and thus, the current light intensity may be maintained (S740). In this case, the current light intensity may correspond to the light intensity in a state where no reduction in light intensity has occurred.

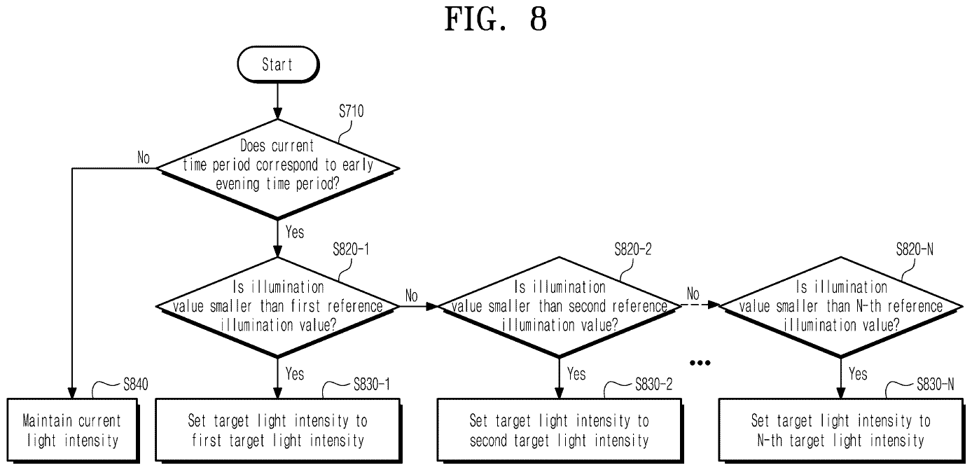

Alternatively, referring to FIG. 8, the lamp control system 10/lamp control method according to the embodiments may determine whether the current time period corresponds to the early evening time period (S810). That is, if the current driving time period corresponds to the early evening time period, it may correspond to a case where control of the light intensity of the beam pattern is necessary as shown in FIG. 4. In step S810, it may be determined whether the current time period corresponds to the early evening time period based on driving data or refined data stored in the memory 620. Alternatively, in step S810, it may be determined whether the current time period corresponds to the early evening time period based on information on the illumination measured by the sensors 200 or 500.

If it is determined in step S810 that the current time period corresponds to the early evening time period, the lamp control system 10/lamp control method according to the embodiments may set the target time and target light intensity as explained in FIG. 4 (S420). In this case, as shown in FIG. 8, the lamp control system 10/lamp control method according to the embodiments may determine whether the current illumination value is smaller than a reference illumination value (S820-1, S820-2, . . . , S820-N).

First, the lamp control system 10/lamp control method according to the embodiments may determine whether the current illumination value is smaller than a first reference illumination value (S820-1). Then, if it is determined in step S820-1 that the current illumination value is smaller than the first reference illumination value, the target light intensity set in step S420 may be configured to correspond to a first target light intensity (S830-1).

Alternatively, if it is determined in step S820-1 that the current illumination value is greater than or equal to the first reference illumination value, it may be determined whether the current illumination value is smaller than a second reference illumination value (S820-2). In this case, the second reference illumination value may be greater than the first reference illumination value. Then, if it is determined in step S820-2 that the current illumination value is smaller than a second reference illumination value, the target light intensity set in step S420 may be configured to correspond to a second target light intensity (S830-2). In this case, the second target light intensity may be smaller than the first target light intensity.

Alternatively, if it is determined in step S820-2 that the current illumination value is greater than or equal to the second reference illumination value, it may be determined whether the current illumination value is smaller than a third reference illumination value. This process may be repeated until it is determined whether the current illumination value is smaller than an N-th reference illumination value (S820-N). In this case, the third reference illumination value may be greater than the second reference illumination value. In other words, the relationship between reference illumination values may be as follows: first reference illumination<second reference illumination<third reference illumination< . . . <N-th reference illumination. If it is determined that the current illumination value is smaller than the third reference illumination value, the target light intensity set in step S420 may be configured to correspond to a third target light intensity. If the current illumination value is smaller than the N-th reference illumination value, the target light intensity set in step S420 may be configured to correspond to an N-th target light intensity (S830-N). In this case, the third target light intensity may be smaller than the second target light intensity. In other words, the relationship between target light intensities may be as follows: first target light intensity>second target light intensity>third target light intensity> . . . >N-th target light intensity.

In other words, the lamp control system 10/lamp control method according to the embodiments may set the target light intensity differently depending on the illumination value of the current driving time period. More specifically, the lamp control system 10/lamp control method according to the embodiments may set the target light intensity to the minimum value as the current illumination value increases (the earlier the evening). The lamp control system 10/lamp control method according to the embodiments has the effect of reducing power consumption by minimizing the target light intensity of the lamp 700 when the moving object 1000 is driving during the early evening time period,

Additionally, if it is determined in step S810 that the current time period is not the early evening time period, it corresponds to a case where light intensity control is not needed, and thus, the current light intensity may be maintained (S840). In this case, the current light intensity may correspond to the light intensity in a state where no reduction in light intensity has occurred.

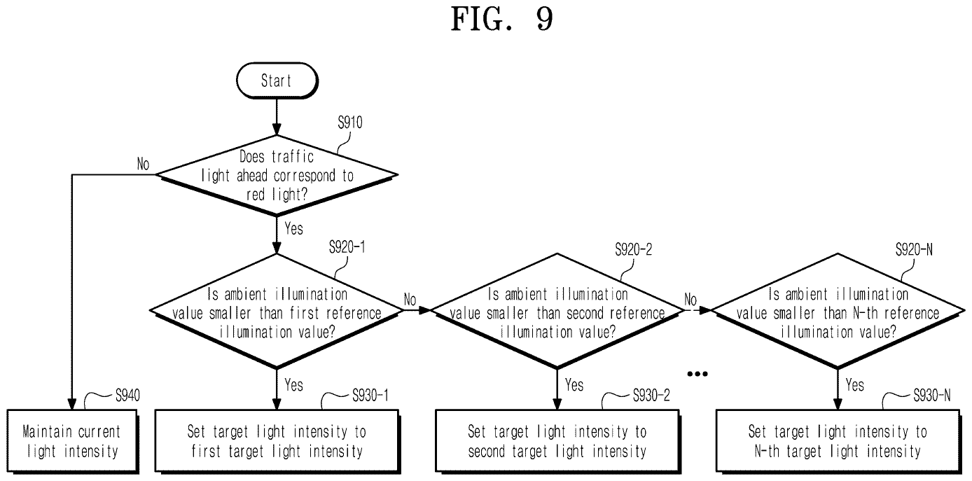

Alternatively, referring to FIG. 9, the lamp control system 10/lamp control method according to the embodiments may determine whether the traffic light ahead corresponds to a red light (S910). That is, if the traffic light ahead corresponds to the red light, it may correspond to a case where control of the light intensity of the beam pattern is necessary as shown in FIG. 4. In step S910, it may be determined whether the traffic light ahead corresponds to the red light based on driving data or refined data stored in the memory 620. Alternatively, in step S910, it may be determined whether the traffic light ahead corresponds to the red light based on information on images measured by the sensors 200 or 500.

If it is determined in step S910 that the traffic light ahead corresponds to the red light, the lamp control system 10/lamp control method according to the embodiments may set the target time and target light intensity as explained in FIG. 4 (S420). In this case, as shown in FIG. 9, the lamp control system 10/lamp control method according to the embodiments may determine whether the current illumination value is smaller than a reference illumination value (S920-1, S920-2, . . . , S920-N).

First, the lamp control system 10/lamp control method according to the embodiments may determine whether the current illumination value is smaller than a first reference illumination value (S920-1). Then, if it is determined in step S920-1 that the current illumination value is smaller than the first reference illumination value, the target light intensity set in step S420 may be configured to correspond to a first target light intensity (S930-1).

Alternatively, if it is determined in step S920-1 that the current illumination value is greater than or equal to the first reference illumination value, it may be determined whether the current illumination value is smaller than a second reference illumination value (S920-2). In this case, the second reference illumination value may be greater than the first reference illumination value. Then, if it is determined in step S920-2 that the current illumination value is smaller than the second reference illumination value, the target light intensity set in step S420 may be configured to correspond to a second target light intensity (S930-2). In this case, the second target light intensity may be smaller than the first target light intensity.

Alternatively, if it is determined in step S920-2 that the current illumination value is greater than or equal to the second reference illumination value, it may be determined whether the current illumination value is smaller than a third reference illumination value. This process may be repeated until it is determined whether the current illumination value is smaller than an N-th reference illumination value (S920-N). In this case, the third reference illumination value may be greater than the second reference illumination value. In other words, the relationship between reference illumination values may be as follows: first reference illumination<second reference illumination<third reference illumination< . . . <N-th reference illumination. If it is determined that the current illumination value is smaller than the third reference illumination value, the target light intensity set in step S420 may be configured to correspond to the third target light intensity. If the current illumination value is smaller than the N-th reference illumination value, the target light intensity set in step S420 may be configured to correspond to an N-th target light intensity (S930-N). In this case, the third target light intensity may be smaller than the second target light intensity. In other words, the relationship between target light intensities may be as follows: first target light intensity>second target light intensity>third target light intensity> . . . >N-th target light intensity.

In other words, the lamp control system 10/lamp control method according to the embodiments may set the target light intensity differently depending on the current illumination value and whether the current traffic light is red. More specifically, the lamp control system 10/lamp control method according to the embodiments may set the target light intensity to the minimum value as the current illumination value increases. The lamp control system 10/lamp control method according to the embodiments has the effect of reducing power consumption by minimizing the target light intensity of the lamp 700 when the traffic light ahead of the moving object 1000 corresponds to a red light, and when the moving object 1000 is in a stopped state while the illumination value is high.

Additionally, if it is determined in step S910 that the traffic light ahead does not correspond to a red light, it corresponds to a case where light intensity control is not needed, and thus, the current light intensity may be maintained (S940). In this case, the current light intensity may correspond to the light intensity in a state where no reduction in light intensity has occurred.

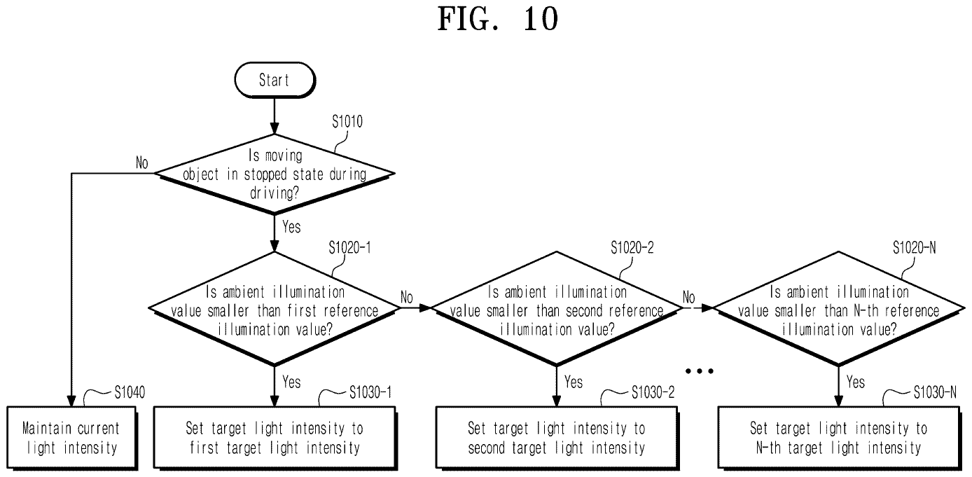

Alternatively, referring to FIG. 10, the lamp control system 10/lamp control method according to the embodiments may determine whether the moving object 1000 is in a stopped state during driving (S1010). That is, if the moving object 1000 is in the stopped state during driving, it may correspond to a case where control of the light intensity of the beam pattern is necessary as shown in FIG. 4. In step S1010, it may be determined whether the moving object 1000 is in the stopped state during driving based on driving data or refined data stored in the memory 620. Alternatively, in step S1010, it may be determined whether the moving object 1000 is in the stopped state during driving based on image information or driving information measured by the sensors 200 or 500.

If it is determined in step S1010 that the moving object 1000 is in the stopped state during driving, the lamp control system 10/lamp control method according to the embodiments may set the target time and target light intensity as explained in FIG. 4 (S420). In this case, as shown in FIG. 10, the lamp control system 10/lamp control method according to the embodiments may determine whether the current illumination value is smaller than a reference illumination value (S1020-1, S1020-2, . . . , S1020-N).

First, the lamp control system 10/lamp control method according to the embodiments may determine whether the current illumination value is smaller than a first reference illumination value (S1020-1). Then, if it is determined in step S1020-1 that the current illumination value is smaller than the first reference illumination value, the target light intensity set in step S420 may be set to correspond to a first target light intensity (S1030-1).

Alternatively, if it is determined in step S1020-1 that the current illumination value is greater than or equal to the first reference illumination value, it may be determined whether the current illumination value is smaller than a second reference illumination value (S1020-2). In this case, the second reference illumination value may be greater than the first reference illumination value. Then, if it is determined in step S1020-2 that the current illumination value is smaller than a second reference illumination value, the target light intensity set in step S420 may be set to correspond to a second target light intensity (S1030-2). In this case, the second target light intensity may be smaller than the first target light intensity.

Alternatively, if it is determined in step S1020-2 that the current illumination value is greater than or equal to the second reference illumination value, it may be determined whether the current illumination value is smaller than a third reference illumination value. This process may be repeated until it is determined whether the current illumination value is smaller than an N-th reference illumination value (S1020-N). In this case, the third reference illumination value may be greater than the second reference illumination value. In other words, the relationship between reference illumination values may be as follows: first reference illumination<second reference illumination<third reference illumination< . . . <N-th reference illumination. Then, if it is determined that the current illumination value is smaller than the third reference illumination value, the target light intensity set in step S420 may be set to correspond to a third target light intensity. If the current illumination value is smaller than the N-th reference illumination value, the target light intensity set in step S420 may be set to correspond to an N-th target light intensity (S1030-N). In this case, the third target light intensity may be smaller than the second target light intensity. In other words, the relationship between target light intensities may be as follows: first target light intensity>second target light intensity>third target light intensity> . . . >N-th target light intensity.

In other words, the lamp control system 10/lamp control method according to the embodiments may set the target light intensity differently depending on the current illumination value when the moving object 1000 is in the stopped state during driving. More specifically, the lamp control system 10/lamp control method according to the embodiments may set the target light intensity to the minimum value as the current illumination value increases. The lamp control system 10/lamp control method according to the embodiments has the effect of reducing power consumption by minimizing the target light intensity of the lamp 700 when the moving object 1000 is in a stopped state during driving, and at the same time, the illumination value is high,

Additionally, if it is determined in step S1010 that the moving object 1000 is not in the stopped state during driving, it corresponds to a case where light intensity control is not needed, and thus, the current light intensity may be maintained (S1040). In this case, the current light intensity may correspond to the light intensity in a state where no reduction in light intensity has occurred.

FIGS. 11 and 12 illustrate examples of setting a step size according to embodiments.

FIGS. 11 and 12 illustrate methods by which the vehicle in FIGS. 1 and 2 or the lamp control system 10 in FIG. 3 controls the lamp based on the autonomous driving integrated controller 600 in FIGS. 1 and 2 or the processor 610 in FIG. 3.

As explained in FIG. 4, the lamp control system 10/lamp control method according to the embodiments may set the step size (S440) and control the light intensity of the lamp 700 by the set step size (S450). FIGS. 11 and 12 show examples of additionally resetting the step size configured in step S440. That is, the step size reset in FIGS. 11 and 12 may differ from the step size reset by Equations 1 and 2, as explained in FIG. 4.

First, referring to FIG. 11, the lamp control system 10/lamp control method according to the embodiments may determine whether there are other moving objects/vehicles or people around the moving object 1000 (S1110). In step S1110, it may be determined whether there are other moving objects/vehicles or people around the moving object 1000 based on driving data or refined data stored in the memory 620. Alternatively, in step S1110, it may be determined whether there are other moving objects/vehicles or people around the moving object 1000 based on image information measured by the sensors 200 or 500.

If it is determined in step S1110 that there are other moving objects/vehicles or people around the moving object 1000, the lamp control system 10/lamp control method according to the embodiments may determine whether the number of detected other moving objects/vehicles or people is smaller than a reference number (S1120-1, S1120-2, . . . , S1120-N). The distance between vehicles may refer to the distance between the moving object 1000 and another moving object.

First, the lamp control system 10/lamp control method according to the embodiments may determine whether the number of detected other moving objects/vehicles or people is smaller than a first reference number (S1120-1). Then, if it is determined in step S1120-1 that the number of detected other moving objects/vehicles or people is smaller than the first reference number, the step size set in step S440 may be reset to correspond to a first step size (S1130-1).

Alternatively, if it is determined in step S1120-1 that the number of detected other moving objects/vehicles or people is greater than or equal to the first reference number, it may be determined whether the number of detected other moving objects/vehicles or people is smaller than a second reference number (S1120-2). In this case, the second reference number may be greater than the first reference number. Then, if it is determined in step S1120-2 that the number of detected other moving objects/vehicles or people is smaller than the second reference number, the step size set in step S440 may be reset to correspond to a second step size (S1130-2). In this case, the second step size may be greater than the first step size.

Alternatively, if it is determined in step S1120-2 that the number of detected other moving objects/vehicles or people is greater than or equal to the second reference number, it may be determined whether the number of detected other moving objects/vehicles or people is smaller than a third reference number. This process may be repeated until it is determined whether the number of detected other moving objects/vehicles or people is smaller than an N-th reference number (S1120-N). In this case, the third reference number may be greater than the second reference number. In other words, the relationship between reference numbers may be as follows: first reference number<second reference number<third reference number< . . . <N-th reference number. If it is determined that the number of detected other moving objects/vehicles or people is smaller than the third reference number, the step size set in step S440 may be reset to correspond to a third step size. If the number of detected other moving objects/vehicles or people is smaller than the N-th reference number, the step size set in step S440 may be reset to correspond to an N-th step size (S1130-N). In this case, the third step size may be greater than the second step size. In other words, the relationship between step sizes may be as follows: first step size<second step size<third step size< . . . <N-th step size.

In other words, the lamp control system 10/lamp control method according to the embodiments may set different step sizes depending on the number of other moving objects/vehicles or people detected around the moving object 1000. More specifically, the lamp control system 10/lamp control method according to the embodiments may set the step size to the minimum value as the number of other moving objects/vehicles or people detected around the moving object 1000 increases.

The lamp control system 10/lamp control method according to the embodiments may control the light intensity of the lamp 700 slowly by reducing the step size when the number of other moving objects/vehicles or people detected around the moving object 1000 is large. On the other hand, the lamp control system 10/lamp control method according to the embodiments may control the light intensity of the lamp 700 quickly by increasing the step size when the number of other moving objects/vehicles or people detected around the moving object 1000 is small. Therefore, the lamp control system 10/lamp control method according to the embodiments has the effect of efficiently controlling the light intensity of the lamp 700 based on the number of other moving objects/vehicles or people detected around the moving object 1000.

Additionally, if it is determined in step S1110 that there are no other moving objects/vehicles or people around the moving object 1000, it corresponds to a case where resetting the step size is not necessary, and thus, the step size set in step S440 may be maintained (S1140). In this case, the step size may correspond to the step size set according to Equations 1 and 2, as explained in FIG. 4.

Alternatively, referring to FIG. 12, the lamp control system 10/lamp control method according to the embodiments may determine whether the current weather is worse than the usual weather (S1210). In step S1210, it may be determined whether the current weather is worse than the usual weather based on driving data or refined data stored in the memory 620. Alternatively, in step S1210, it may be determined whether the current weather is worse than the usual weather based on image information, illumination information, etc., measured by the sensors 200 or 500.

If it is determined in step S1210 that the current weather is worse than the usual weather, the lamp control system 10/lamp control method according to the embodiments may determine whether the current weather satisfies a reference condition (S1220-1, S1220-2, . . . , S1220-N). In this case, the reference condition may correspond to a combination of various factors for assessing the quality of the weather. For example, the reference conditions may include precipitation, wind speed, and other weather-related parameters.

First, the lamp control system 10/lamp control method according to the embodiments may determine whether the current weather satisfies a first reference condition (S1220-1). Then, if it is determined in step S1220-1 that the current weather satisfies the first reference condition, the step size set in step S440 may be reset to correspond to a first step size (S1230-1).

Alternatively, if it is determined in step S1220-1 that the current weather does not satisfy the first reference condition, it may be determined whether the current weather satisfies a second reference condition (S1220-2). In this case, the second reference condition may correspond to weather conditions that are more severe than weather conditions that satisfy the first reference condition. For example, the second reference condition may correspond to higher precipitation, stronger wind, or other more severe weather conditions compared to the first reference condition. Then, if it is determined in step S1220-2 that the current weather satisfies the second reference condition, the step size set in step S440 may be reset to correspond to a second step size (S1230-2). In this case, the second step size may be greater than the first step size.

Alternatively, if it is determined in step S1220-2 that the current weather does not satisfy the second reference condition, it may be determined whether the current weather satisfies a third reference condition. This process may be repeated until it is determined whether the current weather satisfies an N-th reference condition (S1220-N). In this case, the third reference condition may correspond to weather conditions that are more severe than weather conditions that satisfy the second reference condition. In other words, the relationship between reference conditions may be as follows: weather satisfying the first reference condition<weather satisfying the second reference condition<weather satisfying the third reference condition< . . . <weather satisfying the N-th reference condition, where the order indicates that the weather becomes more severe. Then, if it is determined that the current weather satisfies the third reference condition, the step size set in step S440 may be reset to correspond to a third step size. If it is determined that the current weather satisfies the N-th reference condition, the step size set in step S440 may be reset to correspond to the N-th step size (S1230-N). In this case, the third step size may be greater than the second step size. In other words, the relationship between step sizes may be as follows: first step size<second step size<third step size< . . . <N-th step size.

In other words, the lamp control system 10/lamp control method according to the embodiments may set different step sizes depending on the current weather. More specifically, the lamp control system 10/lamp control method according to the embodiments may set the step size to the minimum value as the current weather improves.

The lamp control system 10/lamp control method according to the embodiments may control the light intensity of the lamp 700 slowly by reducing the step size as the current weather improves. On the other hand, the lamp control system 10/lamp control method according to the embodiments may control the light intensity of the lamp 700 quickly by increasing the step size as the current weather becomes more severe. Therefore, the lamp control system 10/lamp control method according to the embodiments has the effect of efficiently controlling the light intensity of the lamp 700 based on the current weather.

Additionally, if it is determined in step S1210 that the current weather is good, it corresponds to a case where resetting the step size is not necessary, and thus, the step size set in step S440 may be maintained (S1240). In this case, the step size may correspond to the step size set according to Equations 1 and 2, as explained in FIG. 4.

Therefore, the lamp control system 10/lamp control method according to the embodiments has the effect of controlling the light intensity of the lamp 700 such that other moving objects or drivers do not notice the control of the light intensity of the lamp 700. Additionally, the lamp control system 10/lamp control method according to the embodiments has the effect of efficiently controlling the light intensity of the lamp 700 by quickly adjusting the light intensity control when the surrounding conditions or weather prevent other moving objects or people from noticing the changes.

The embodiments have been described in terms of the method and/or the device, and the descriptions of the method and the device may be applied in a complementary manner.

For convenience of description, the description has been made with the respective drawing, but it is also available to design a new embodiment by combining the embodiments described with the respective drawings to each other. In addition, designing a computer-readable recording medium in which a program for executing the embodiments described above is recorded based on needs of a person skilled in the art is also within the scope of the embodiments. In the device and the method according to the embodiments, the configurations and the methods of the embodiments as described above may not be applied in a limited manner, but all or some of the embodiments may be selectively combined with each other such that various modifications may be made. Although the preferred embodiments of the embodiments have been illustrated and described, the embodiments may not be limited to the specific embodiments described above, various modifications may be made by a person skilled in the art to which the invention pertains without departing from the gist of the embodiments claimed in the claims, and such modifications should not be individually understood from the technical ideas or prospects of the embodiments.

The various components of the device of the embodiments may be implemented by hardware, software, firmware, or combinations thereof. The various components of the embodiments may be implemented via a single chip, for example, a single hardware circuit. Depending on the embodiments, the components of the embodiments may be implemented via separate chips. Depending on the embodiments, at least one of the components of the device of the embodiments may be composed of one or more processors that may execute one or more programs, and the one or more programs may perform, or include instructions for performing, one or more of the operations/methods according to the embodiments. Executable instructions for performing the methods/operations of the device of the embodiments may be stored in a non-transitory CRM or other computer program products built to be executed by the one or more processors, or may be stored in a transitory CRM or other computer program products built to be executed by the one or more processors. In addition, the memory of the embodiments may be used as a concept including not only a volatile memory (e.g., a RAM or the like), but also a non-volatile memory, a flash memory, a PROM, and the like. Additionally, the memory may include implementations in a form of carrier wave, such as transmission via the Internet. Additionally, a processor-readable recording medium may store processor-readable code in a distributed manner across a computer system connected via a network, allowing the code to be executed in a distributed fashion.

In this document, “/” and “,” are interpreted as “and/or.” For example, “A/B” is interpreted as “A and/or B,” and “A, B” is interpreted as “A and/or B.” Additionally, “A/B/C” means “at least one of A, B, and/or C.” Also, “A, B, C” means “at least one of A, B, and/or C.” Additionally, “or” in this document is interpreted as “and/or.” For example, “A or B” may mean 1) “A” only, 2) “B” only, or 3) “A and B”. In other words, “or” in this document may mean “additionally or alternatively.”

Terms such as first, second, and the like may be used to describe various components of the embodiments. However, the various components according to the embodiments should not be limited in their interpretation by these terms. These terms are merely used to distinguish one component from another. For example, a first user input signal may be referred to as a second user input signal. Similarly, the second user input signal may be referred to as the first user input signal. The use of these terms should be interpreted as not departing from the scope of the various embodiments. Although the first user input signal and the second user input signal are both user input signals, they do not mean the same user input signal unless the context clearly indicates otherwise.

The terminology used to describe the embodiments is for the purpose of describing particular embodiments and is not intended to be limiting of the embodiments. As used in the description of the embodiments and in the claims, the singular expression is intended to include the plural expression unless the context clearly dictates otherwise. The expression “and/or” is used to have a meaning including all possible combinations of the terms. The expression “include” describes the presence of features, numbers, steps, elements, and/or components, but does not mean that additional features, numbers, steps, elements, and/or components are not included. Conditional expressions such as “in case of ˜,” “when ˜,” and the like used to describe the embodiments are not interpreted as being limited to only optional cases. Rather, they are intended to mean that, when specific conditions are satisfied, corresponding operations are performed, or relevant definitions are interpreted accordingly.

In addition, the operations according to the embodiments described in this document may be performed by a transceiver including the memory and/or the processor according to the embodiments. The memory may store programs for processing/controlling the operations according to the embodiments, and the processor may control the various operations described in this document. The processor may be referred to as a controller or the like. The operations according to the embodiments may be performed by firmware, software, and/or combinations thereof, and the firmware, the software, and/or the combinations thereof may be stored in the processor or in the memory.

In one example, the operations according to the embodiments described above may be performed by a transmitter and/or a receiver according to the embodiments. The transceiver may include a transceiver unit that transmits and receives media data, a memory that stores instructions (program codes, algorithms, flowcharts, and/or data) for a process according to the embodiments, and a processor that controls operations of the transceiver.

The processor may be referred to as the controller or the like, and may correspond to, for example, hardware, software, and/or combinations thereof. The operations according to the embodiments described above may be performed by the processor. In addition, the processor may be implemented as an encoder/decoder or the like for the operations of the embodiments described above.

As described above, the relevant content has been described in the best mode for carrying out the embodiments.

As described above, the embodiments may be applied entirely or partially to autonomous valet driving device and system.

Those skilled in the art may make various changes or modifications to the embodiments within the scope of the embodiments.

The embodiments may include the changes/modifications, and the changes/modifications may not depart from the scope of the claims and equivalents thereof.

What is claimed is:

1. A lamp control system for a moving object, comprising:
a lamp configured to emit a beam pattern;
a memory configured to store driving data and refined data obtained by analyzing the driving data; and
a processor configured to set a target time and a target light intensity for controlling the beam pattern based on the data stored in the memory and control a light intensity of the beam pattern to reach the target light intensity within the target time.

2. The lamp control system of claim 1, wherein the processor is configured to set the target light intensity differently depending on a distance between the moving object and at least one other moving object, a length of a streetlight section, or a length of a tunnel section, and
wherein the distance between the moving object and the at least one other moving object, the length of the streetlight section, and the length of the tunnel section are included in the driving data.

3. The lamp control system of claim 2, wherein the target light intensity is configured to have a smaller value as the distance between the moving object and the at least one other moving object decreases.

4. The lamp control system of claim 2, wherein the target light intensity is configured to have a smaller value as the length of the streetlight section or the length of the tunnel section increases.

5. The lamp control system of claim 1, wherein the processor is configured to set the target light intensity differently depending on an illumination value in the driving data.

6. The lamp control system of claim 5, wherein the target light intensity is configured to have a smaller value as the illumination value increases.

7. The lamp control system of claim 1, wherein the processor is configured to:
set a control amount per step based on the target time and the target light intensity; and
sequentially control the light intensity of the beam pattern according to the control amount per step.

8. The lamp control system of claim 7, wherein the processor is configured to configure the control amount per step based on a number of surrounding objects or weather information included in the driving data.

9. A lamp control method for a moving object, performed by a lamp control system having a lamp configured to emit a beam pattern in a forward direction, and the method comprising:
extracting one or both of driving data and refined data obtained by analyzing the driving data;
setting a target time and a target light intensity for controlling the beam pattern based on the extracted data; and
controlling a light intensity of the beam pattern to reach the target light intensity within the target time.

10. The lamp control method of claim 9, further comprising:
setting the target light intensity differently depending on a distance between the moving object and at least one other moving object, a length of a streetlight section, or a length of a tunnel section, and
wherein the distance between the moving object and the at least one other moving object, the length of the streetlight section, and the length of the tunnel section are included in the driving data.

11. The lamp control method of claim 10, wherein the target light intensity is configured to have a smaller value as the distance between the moving object and the at least one other moving object decreases.

12. The lamp control method of claim 10, wherein the target light intensity is configured to have a smaller value as the length of the streetlight section or the length of the tunnel section increases.

13. The lamp control method of claim 9, further comprising:
setting the target light intensity differently depending on an illumination value in the driving data.

14. The lamp control method of claim 13, wherein the target light intensity is configured to have a smaller value as the illumination value increases.

15. The lamp control method of claim 9, further comprising:
setting a control amount per step based on the target time and the target light intensity and;
sequentially controlling the light intensity of the beam pattern according to the control amount per step.

16. The lamp control method of claim 15, further comprising:
configuring the control amount per step based on a number of surrounding objects or weather information included in the driving data.

17. A moving object comprising:
a lamp configured to emit a beam pattern;
a memory configured to store driving data and refined data obtained by analyzing the driving data; and
a processor configured to set a target time and a target light intensity for controlling the beam pattern based on the data stored in the memory and control a light intensity of the beam pattern to reach the target light intensity within the target time.

18. The moving object of claim 17, wherein the processor is configured to set the target light intensity differently depending on a distance between the moving object and at least one other moving object, a length of a streetlight section, or a length of a tunnel section, and
wherein the distance between the moving object and the at least one other moving object, the length of the streetlight section, and the length of the tunnel section are included in the driving data.

19. The moving object of claim 18, wherein the target light intensity is configured to have a smaller value as the distance between the moving object and the at least one other moving object decreases.

20. The moving object of claim 18, wherein the target light intensity is configured to have a smaller value as the length of the streetlight section or the length of the tunnel section increases.
